(19) United States
(12) Patent Application Publication
(10) Pub. No.: US 2008/0281869 A1
(43) Pub. Date: Nov. 13, 2008

(54) Apparatus and Method Of Map Engine Clustering Automation

(75) Inventors: Li Liu, Woodbridge (CA); Yin Chung Lai, Markham (CA)

Correspondence Address: DOWNS RACHLIN MARTIN PLLC, 199 MAIN STREET, P O BOX 190, BURLINGTON, VT, 05402-0190, US

(73) Assignee: ENOWHIRING, INC., Toronto (CA)

(21) Appl. No.: 12/116,537

(22) Filed: May 7, 2008

Related U.S. Application Data
(60) Provisional application No. 60/924,261, filed on May 7, 2007.

(51) Int. Cl. G06F 7/06; G06F 15/16; G06F 17/30

(52) U.S. Cl. 707/104.1; 709/203; 707/E17.008; 707/E17.018

(57) ABSTRACT

A system for clustering map information includes a map engine clustering automation (MECA) module communicating with a map engine to receive at least map content data from the map engine. In one embodiment, the MECA module clusters the at least map content data automatically to provide at least clustered map content data that is clustered on the basis of proximity. The system also includes a client communicating with the MECA module to receive the at least clustered map content data and display the at least clustered map content data. A method of map engine clustering automation is also included. In one embodiment, the method includes filtering a list of postings resulting in a first list of remaining postings. The first list is clustered so that postings that are substantially proximate are clustered resulting in clustered map points corresponding to postings which were clustered.

### CROSS-REFERENCE TO RELATED APPLICATIONS

This application claims the benefit of priority from U.S. Provisional Application Ser. No. 60/924,261, filed May 7, 2007, and titled Apparatus and Method of Map Engine Clustering Automation, which is incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This application relates to map engines in general, and to an apparatus and method of map engine clustering automation, in particular.

### BACKGROUND

A mashup is a website or application that combines content from more than one source into an integrated experience.

Many mashups use map data as one source of content. This is typically accomplished using a map engine, such as an online or offline map service. Examples of online map services are Google Maps, Microsoft Virtual Earth, and Yahoo! Maps. Examples of offline or desktop or mobile map services are Microsoft MapPoint, Google Earth, Microsoft Streets and Maps.

Mashups that use map data typically list a known finite small number of pushpins on a map, such as listing traffic cameras along a highway, or Beer stores in a downtown area.

A problem exists however with some mashups that use map data which may need to list a sufficiently large number of pushpins on a map so as to introduce a performance bottleneck. The more points requiring a pushpin on a map, the slower the map may load, thus greatly affecting performance, map usability and user experience.

When a client-side implementation that runs on the client computer is used to access the map data and display it to the user, this performance issue cannot be solved by simply adding additional server infrastructure. For example, Google Maps and other map services use Javascript and the like to access the content through an API (Application Programmers Interface). Javascript is a client-side scripting language that runs on the client computer so that the performance of loading the map depends on each individual's client computer speed. Furthermore, an excess of pushpins on a map adds confusion and lowers usability of the map.

Consequently, there is a need to increase the performance and/or usability of mashups that use map data which list a sufficiently large number of pushpins on a map.

### SUMMARY

Broadly, a decrease of pushpins based on appropriate zoom level and using suitable techniques to automatically cluster points greatly increases performance, usability, and user experience.

In one embodiment, there is provided: an apparatus of map engine clustering automation, the apparatus comprising: (a) a map engine clustering automation (MECA) module communicating with the map engine to receive at least map content data from the map engine, the MECA module clustering the at least map content data automatically to provide at least clustered map content data that is clustered on the basis of proximity; and (b) a client communicating with the MECA module to receive the at least clustered map content data, the client displaying the at least clustered map content data.

In another embodiment, there is provided: a method of map engine clustering automation, the method comprising the steps of: (a) receiving map data from the map engine; (b) retrieving a list of postings for processing in relation to the map data; (c) filtering the list postings based on criteria so that postings that match the criteria are filtered according to a filtering operation resulting in filtered map points corresponding to postings which were filtered and a first list of remaining postings which were not filtered; (d) clustering the first list of remaining postings so that postings that are substantially proximate are clustered according to a clustering operation resulting in clustered map points corresponding to postings which were clustered and a second list of remaining postings which were not clustered; and (e) providing a list of points and related posting information destined to be displayed on a map.

Other aspects and features of the present invention will become apparent to those ordinarily skilled in the art upon review of the following description of specific embodiments of an apparatus and method of map engine clustering automation in conjunction with the accompanying drawing figures.

### BRIEF DESCRIPTION OF THE DRAWINGS

Embodiments of the present invention will now be described, by way of example only, with reference to the accompanying drawing figures, wherein:

FIG. 1 is a block diagram illustrating a first embodiment of an apparatus of map engine clustering automation;

FIGS. 2a-d is a source code listing illustrating a first embodiment of a method of map engine clustering automation;

FIG. 3 is a flowchart illustrating a second embodiment of a method of map engine clustering automation;

FIG. 4 is a flowchart illustrating in greater detail the acts of each step of the second embodiment of a method of map engine clustering automation in FIG. 3;

FIG. 5 is a block diagram illustrating a second embodiment of an apparatus of map engine clustering automation; and

FIG. 6 is a block diagram illustrating a third embodiment of an apparatus of map engine clustering automation.

Like reference numerals are used in different figures to denote similar elements.

### DETAILED DESCRIPTION OF THE DRAWINGS

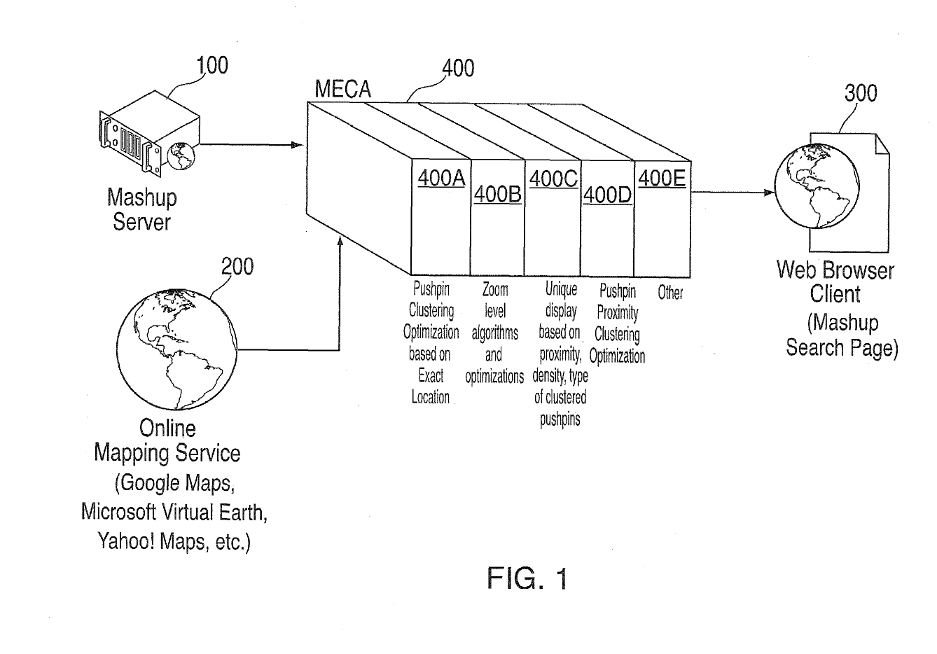

Referring to the first sheet of the drawings, FIG. 1 is a block diagram illustrating a first embodiment of an apparatus of map engine clustering automation. The first embodiment of the apparatus includes a mashup server 100, an online mapping service 200, a web browser client 300, and a map engine clustering automation (MECA) module 400. Mashup server 100 provides web browser client 300 with search results which include inter alia content from online mapping service 200.

It is contemplated that online mapping service 200 could be Google Maps, Microsoft Virtual Earth, Yahoo! Maps, and the like. It is also contemplated that the service could be an offline or desktop or mobile mapping service such as Microsoft MapPoint, Google Earth, Microsoft Streets and Maps, and the like.

Web browser client 300 requests mashup search results from mashup server 100 and online mapping service 200. Advantageously, MECA 400 automatically clusters the search results. As illustrated MECA 400 operates various automatic optimizations using a layered approach: pushpin clustering optimization based on exact location 400A, zoom level algorithms and optimizations 400B, unique display based on proximity, density, type of clustered pushpins 400C, pushpin proximity clustering optimization 400D, as well as other 400E optimizations.

Although not expressly shown in the drawings, the method of communication between the various components illustrated uses the Internet Protocol (IP), Application Programming Interfaces (API), or a combination of both.

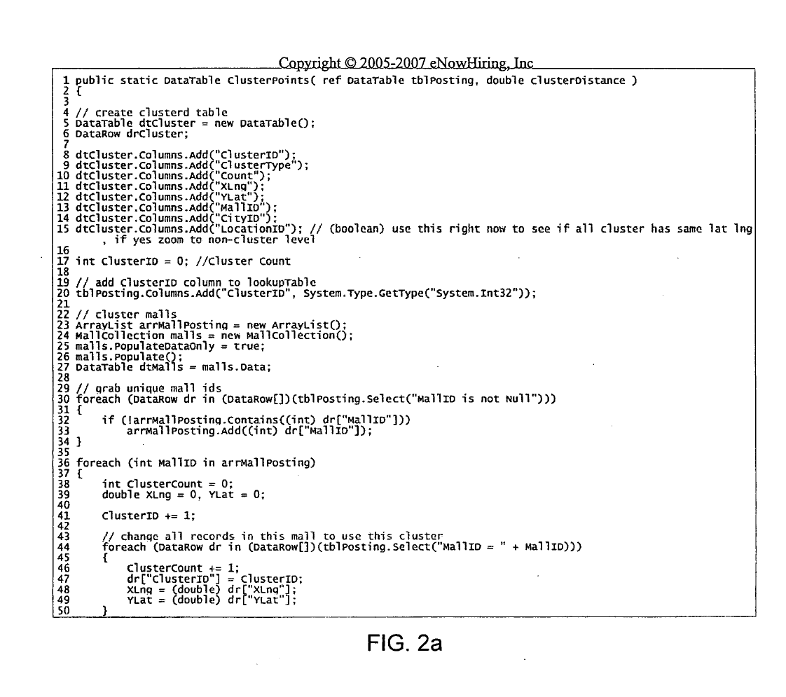

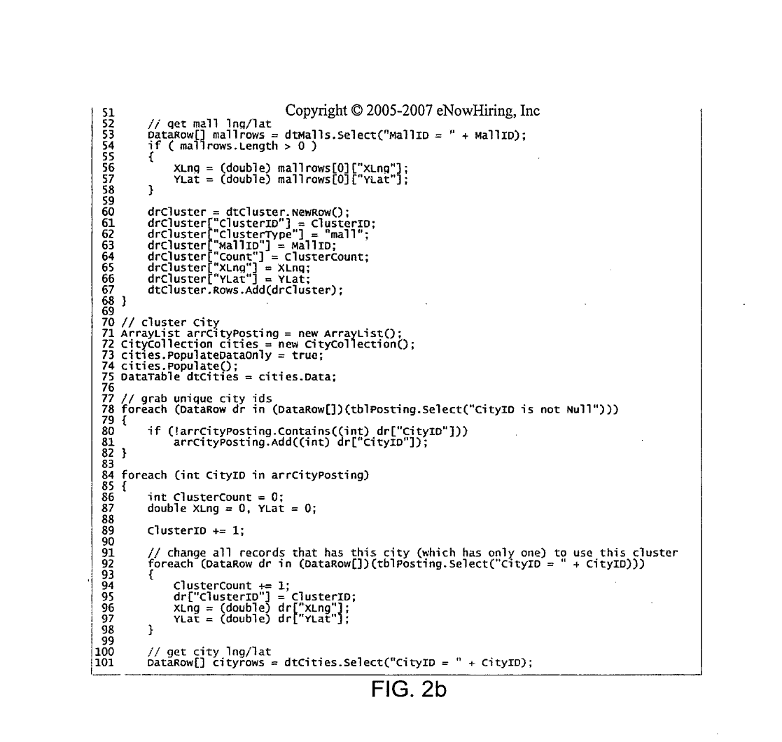

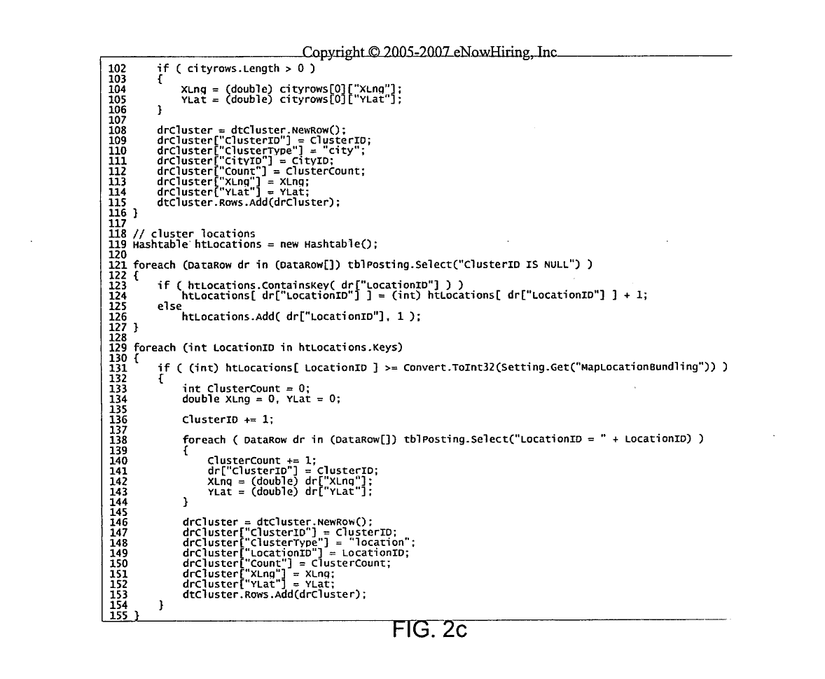

Referring to the second to fifth sheets of the drawings, FIGS. 2a-d is a source code listing illustrating a first embodiment of a method of map engine clustering automation. The source code listing has 198 lines and is provided in four figures: FIG. 2a lists lines 1-50; FIG. 2b lists lines 51-101; FIG. 2c lists lines 102-155; and FIG. 2d lists lines 156-198.

A first step is taken at lines 5-20, where a cluster table is created having the following columns: ClusterID, ClusterType, Count, XLng, YLat, MallID, CityID, LocationID.

A second step is taken at lines 22-27, where a list of malls is retrieved.

A third step is taken at lines 29-34, where a list of postings that belong to malls is retrieved and a unique list of MallIDs is generated based on the list of postings and the result is stored in arrMallPosting.

A fourth step is taken at lines 36-68, where a list of postings that belong to the current MallID is retrieved and added to the cluster. The lat/long coordinate of the MallID stored on file is used to create the point for cluster.

A fifth step is taken at lines 70-75, where a list of cities or regions is retrieved.

A sixth step is taken at lines 77-82, where a list of postings that belong to regions is retrieved and a unique list of CityIDs is generated based on the list of postings and the result is stored in arrCityPosting.

A seventh step is taken at lines 84-116, where a list of postings that belong to the current CityID is retrieved and added to the cluster. The lat/long coordinate of the CityID stored on file is used to create the point for the cluster.

An eighth step is taken at lines 118-127, where a list of postings at the same company location with identical lat/long coordinates are tallied.

A ninth step is taken at lines 129-155, where the tallied list of postings at identical lat/long coordinates is clustered if the tallied count is more than MapLocationBundling (which is current set to 5).

A tenth step is taken at lines 157-195, where all remaining points not yet clustered (through malls, regions, same locations, etc) is processed for clustering.

A eleventh step is taken at lines 160-170, where the first posting in the remaining list of postings is used to determine the size of the box (or radius). A search is performed to determine all other points that fall into the radius.

A twelfth step is taken at lines 172-194, where the search results from all identified points within the radius is averaged to automatically determine the point of cluster.

A thirteenth step is taken at lines 197, where all clustered points, points that did not fall into the realm of other clusters are returned as output.

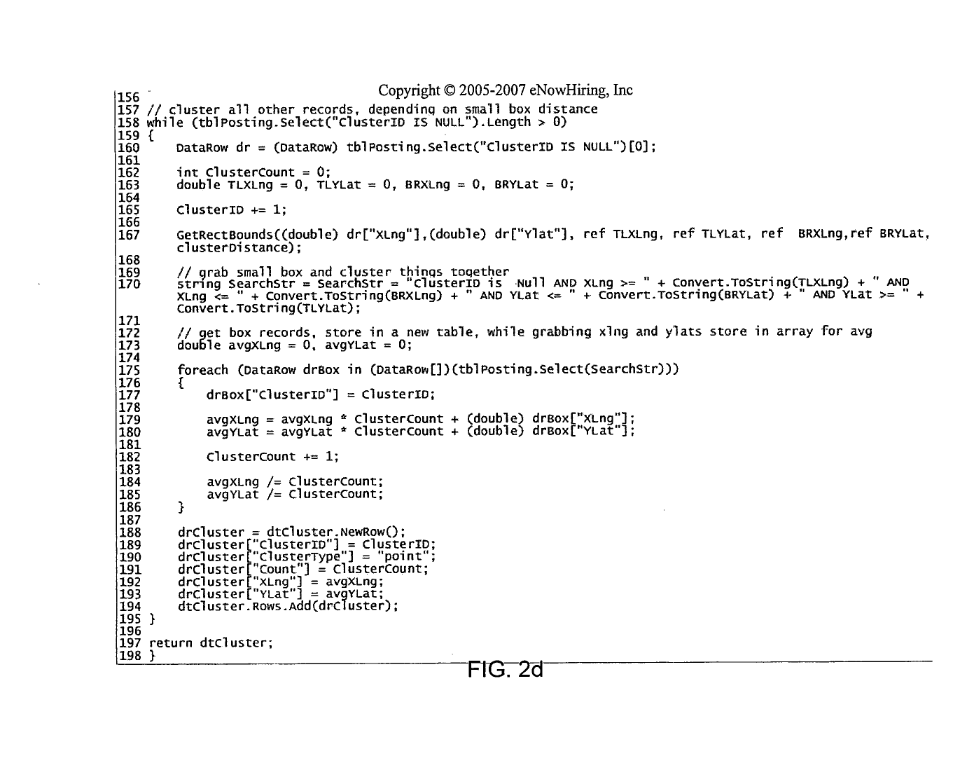

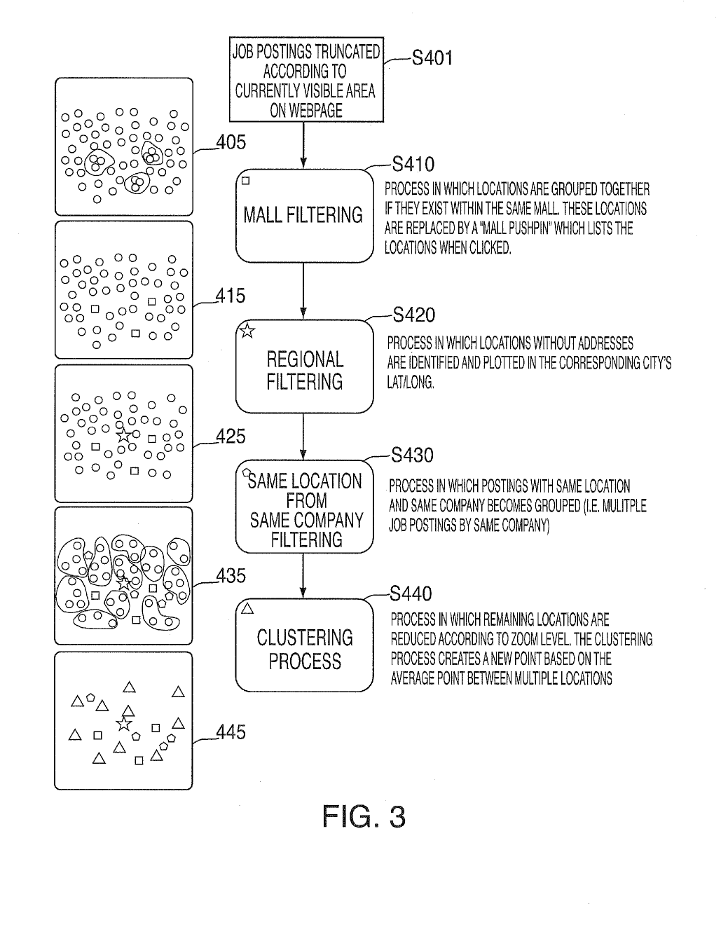

Referring to the sixth sheet of the drawings, FIG. 3 is a flowchart illustrating a second embodiment of a method of map engine clustering automation. The second embodiment is adapted to the particular requirements of a job posting mashup.

As used in this specification and in the amended claims, a “posting” means any information which can normally be attributed to a job posting, housing listing, commercial or residential establishment, map pushpin, map marker, map point or the like.

At the posting truncating step S401, job postings are truncated according to the currently visible area 405 of a map on a web page of a web browser client.

At the mall filtering step S410, locations are grouped together if they exist within the same mall. These locations are replaced by a “mall pushpin” which lists the locations when clicked, as illustrated in currently visible area 415 of the map. Using additional information provided by each posting, the locations can be clustered when posting have similar characteristics, such as being in the similar mall, building, park, etc. Even if the exact location of the posting is not the same as the mall, it will be shown clustered with other locations from the same mall. We can assume that the location is very close to the mall if it's not in the mall. This provides the most value to users to locate postings from that mall.

At the regional filtering step S420, locations without addresses are identified and plotted in the corresponding city's lat/long, as illustrated in currently visible area 425 of the map. These set of filtered postings only have regional information such as its administrative locality, city, state and/or country but does not have a specific address that can differentiate them individually. Therefore they are clustered into a locality points, city points, state points, country points or any other type of regional indicator depending on the most accurate information that is provided by the posting.

At the same location from same company filtering step S430, postings with same location and same company becomes grouped. (i.e. Multiple job postings by same company), as illustrated in currently visible area 435 of the map.

At the clustering step S440, the number of remaining locations that has detailed address information and does not have characteristics (such as being in a mall, or located in the same store, etc.) that has been set to be filtered upon is reduced for increased usability and increased performance using an algorithm. This algorithm evaluates the distance between each of these locations and creates a new clustered point (based on an algorithm such as a mathematical average of the points, the lat/long coordinates of any of the points, or by some other mathematical means that will result in a single point) as shown in S445. The level of proximity required for a location to be clustered with another location is determined by and is dynamically changed according to the current zoom level. By doing so, the user will experience optimized performance and usability at every zoom level.

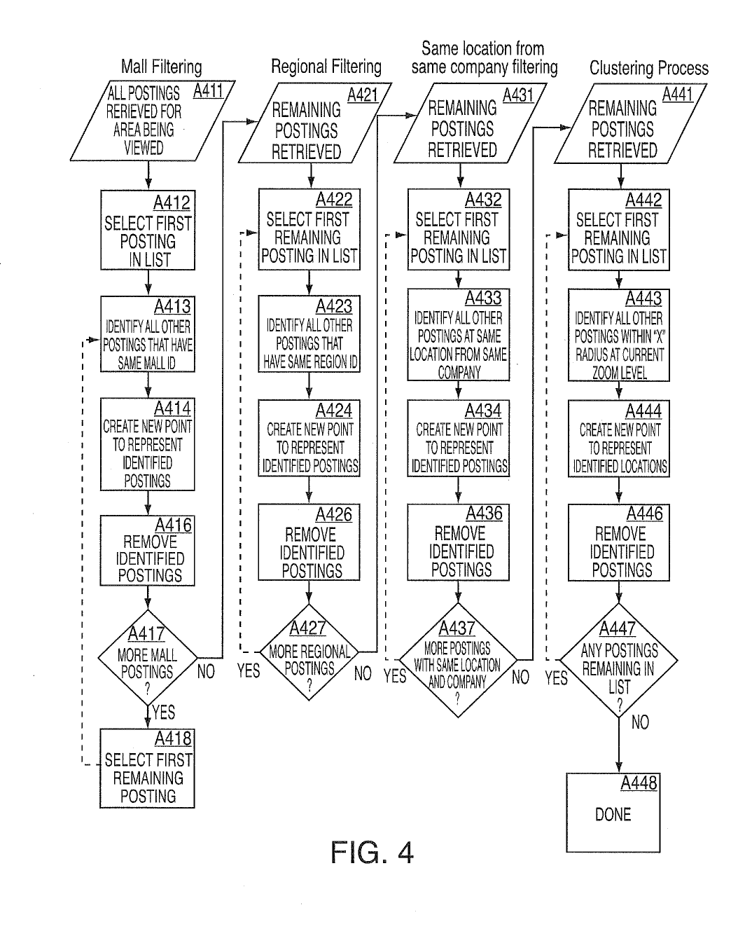

Referring to the seventh sheet of the drawings, FIG. 4 is a flowchart illustrating in greater detail the acts of each step of the second embodiment of a method of map engine clustering automation in FIG. 3.

Although example acts of the posting truncating step S401 have not been illustrated in FIG. 4, contemplated acts include using a bounding region to limit the postings based on the location of the postings whereby postings whose locations are outside the bounding region (ie: 50 km radius or box) are truncated. In alternative embodiments, the bounding region corresponds to the visible area of the map, or alternatively to a smaller area which is defined by where the visitor moves to on the visible area of the map.

The mall or building filtering step S410 of FIG. 3 can be carried out using the example acts A411, A412, A413, A414, A416, A417 and A418 illustrated in FIG. 4:
At the postings retrieving act A411, all postings are retrieved for the area being viewed;
At the selecting first posting act A412, the first posting in the list is selected;
At the identifying postings with same mall act A413, the postings that have the same Mall or Building ID are identified;
At the creating point act A414, a new point is created to represent the postings identified;
At the removing identified postings act A416, postings having been represented with a single point are removed;
At the determining act A417, it is determined whether or not more mall postings are present, and if present act A418 is performed or else act A421 of the regional filtering step S420 is performed; and
At the selecting remaining posting act A418, the first remaining posting is selected, after which act A413 is performed.

The regional filtering step S420 of FIG. 3 can be carried out using the example acts A421, A422, A423, A424, A426 and A427 illustrated in FIG. 4:
At the remaining postings retrieving act A421, the remaining postings that have not been subject to mall filtering are retrieved;
At the selecting first remaining posting act A422, the first remaining posting is selected;
At the identifying postings with same region act A423, the postings that have the same Region or City or Administrative Locality ID are identified;
At the creating point act A424, a new point is created to represent the postings identified;
At the removing identified postings act A426, postings having been represented with a single point are removed; and
At the determining act A427, it is determined whether or not more regional postings are present, and if present act A422 is performed or else act A431 of the regional filtering step S420 is performed.

The same location from same company filtering step S430 of FIG. 3 can be carried out using the example acts A431, A432, A433, A434, A436 and A437 illustrated in FIG. 4:
At the remaining postings retrieving act A431, the remaining postings that have not been subject to either mall or regional filtering are retrieved;
At the selecting first remaining posting act A432, the first remaining posting is selected;
At the identifying postings with same location from same company act A423, the postings that have the same location from the same company are identified;
At the creating point act A434, a new point is created to represent the postings identified;
At the removing identified postings act A436, postings having been represented with a single point are removed; and
At the determining act A437, it is determined whether or not more postings with same location from same company are present, and if present act A432 is performed or else act A441 of the clustering step S440 is performed.

The clustering step S440 of FIG. 3 can be carried out using the example acts A441, A442, A443, A444, A446 and A447 illustrated in FIG. 4:
At the remaining postings retrieving act A441, the remaining postings that have not been subject to mallibuilding, regional, or same location from same company filtering are retrieved;
At the selecting first remaining posting act A442, the first remaining posting is selected;
At the identifying postings within radius act A443, the postings within a specific radius, x, at the current zoom level of the identified posting are identified;
At the creating point act A444, a new point is created to represent the postings identified;
At the removing identified postings act A446, postings having been represented with a single point are removed; and
At the determining act A447, it is determined whether or not more postings are present, and if present act A442 is performed or else act A448 is performed whereby the method is done.

Although not expressly shown in the drawings, the above four exemplary species of acts to carry out a filtering step point to the following generic acts for providing a filtering step:
At a remaining postings retrieving act, the remaining postings that have not yet been subject to filtering are retrieved;
At a selecting first remaining posting act, the first remaining posting is selected;
At an identifying postings with same criteria act, the postings that have the same criteria are identified;
At a creating point act, a new point is created to represent the postings identified with the same criteria;
At a removing identified postings act, postings having been represented with a single point are removed; and
At the determining act, it is determined whether or not more postings with same criteria are present, and if present the selecting first remaining act is performed or else filtering according to other criteria is optionally performed.

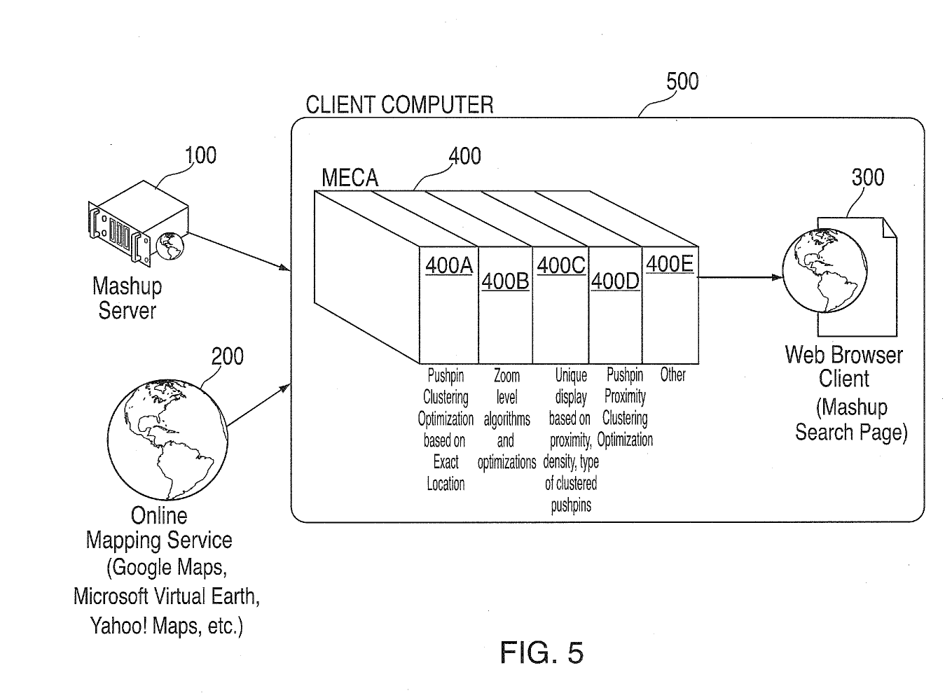

Referring to the eighth sheet of the drawings, FIG. 5 is a block diagram illustrating a second embodiment of an apparatus of map engine clustering automation. As compared to the first embodiment illustrated in FIG. 1, this second embodiment illustrates that the MECA module 400 and the Web Browser Client 300 are both provided on a client computer system 500.

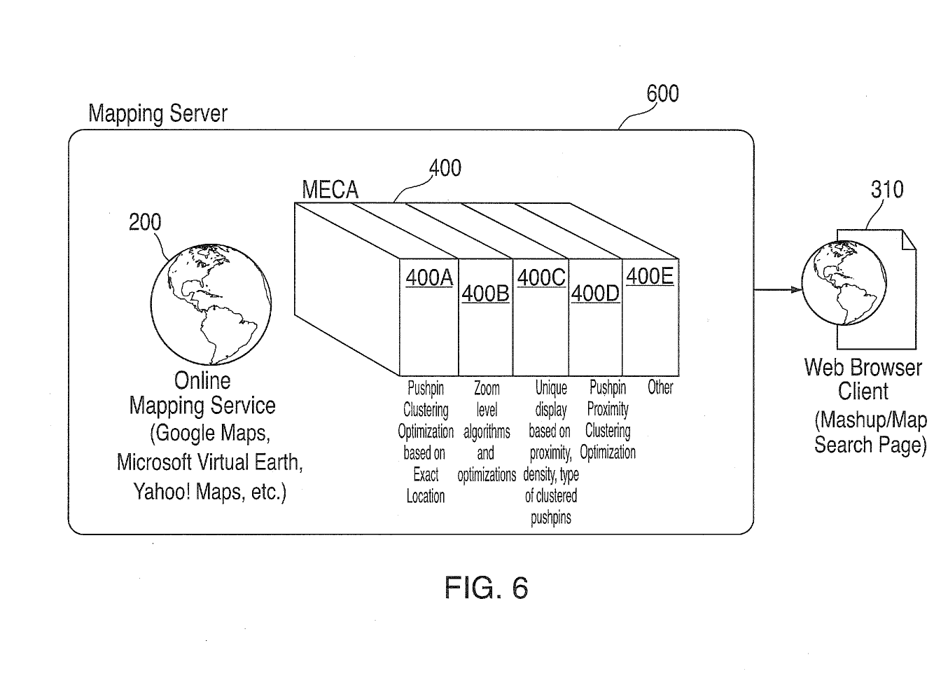

Referring to the ninth sheet of the drawings, FIG. 6 is a block diagram illustrating a third embodiment of an apparatus of map engine clustering automation. As compared to the first embodiment illustrated in FIG. 1, this third embodiment illustrates that the MECA module 400 and the Online Mapping Service 200 are both provided on a Mapping Server system 600. Advantageously, the mashup server 100 of the first and second embodiments has been eliminated, i.e. the MECA module 400 has been “integrated” with the Online Mapping Service.

Although not expressly shown in the drawings, it is contemplated to locate the MECA module and the mashup server in a mashup server computer system.

Although not expressly shown in the drawings, an alternative to the clustering of pushpins together is to restrict the amount of points loaded until a client user moves to that part of the map, and that such variation of the method and apparatus disclosed herein is within the scope of the present invention as a person of ordinary skill in the art would be able to accomplish this restriction in lieu of the clustering in view of the present disclosure.

Although not expressly shown in the drawings, the simplest way to cluster pushpins on a map is to eliminate the duplicate pushpins at the exact same location. If 5 pins were at the exact same latitude/longitude coordinate, all 5 would be stacked directly on top of one another on the map. However, only 1 of the 5 would be accessible and can be clicked on, which is the one at the very top; the other 4 hidden pins would still be loaded, taking time and processing power, but would serve no purpose since a visitor cannot see it or click on it. In one example, our optimization automatically identifies the 4 hidden pins and saves processing power by not loading the pins. In another example, our method also adds additional data to the top pin so that it lists information for all 5 pins in a scrolling display.

Although not expressly shown in the drawings, clustering pushpins that are not at the exact same latitude/longitude coordinate are contemplated. In view of the present disclosure, a person of ordinary skill, such as existing Google Maps mashup developmers, would be able to implement the details of this implementation. Additional algorithms are put in place to determine how to cluster pushpins that are within close proximity but not at the exact same location. We also have an algorithm to determine how to show the 1 pushpin that is clustered on the map, taking into consideration, proximity, density of pins, type of pins involved (ie: from same company, same location from same company or varied companies and locations). Of course, this clustering technique would not be completely useful if it does not take zoom levels into consideration. We've disclosed additional algorithms to handle various zoom levels so that when zoomed out far enough to see provinces and states, the map would still perform well.

The techniques disclosed herein do not simply address a limitation or performance bottleneck for Google Maps, but rather apply to other mapping systems and methods, such as any JavaScript-based mapping technology which is used by the top 3 providers for online interactive mapping services today, Microsoft Virtual Earth, Google Maps and Yahoo! Maps. So anyone who uses one or more other mapping services, such as Microsoft, Google, or Yahoo! will also benefit significantly in performance if using the techniques disclosed herein combined with the algorithms disclosed herein.

The scope of a system and/or method as disclosed herein also goes beyond just jobs. Pretty much any mapping application which uses large amounts of pushpins would benefit from this technology to achieve high performance results.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus of map engine clustering automation, the apparatus comprising:
a map engine clustering automation (MECA) module communicating with the map engine to receive at least map content data from the map engine, the MECA module clustering the at least map content data automatically to provide at least clustered map content data that is clustered on the basis of proximity; and
a client communicating with the MECA module to receive the at least clustered map content data, the client displaying the at least clustered map content data.

2. The apparatus as recited in claim 1, wherein the client is a web browser client.

3. The apparatus as recited in claim 1, wherein the at least clustered map content data includes information related to a posting.

4. The apparatus as recited in claim 3, wherein the posting is selected from the group consisting of a job posting and a real-estate posting.

5. The apparatus as recited in claim 1, wherein the map engine is an online mapping service.

6. The apparatus as recited in claim 5, wherein the online mapping service is selected from the group consisting of Google Maps, Microsoft Virtual Earth, and Yahoo! Maps.

7. The apparatus as recited in claim 1, wherein the map engine is selected from the group consisting of Microsoft MapPoint, Google Earth, and Microsoft Streets and Maps.

8. The apparatus as recited in claim 1, further comprising a mashup server communicating with the MECA module to provide content data to the MECA module.

9. The apparatus as recited in claim 8, wherein the MECA module is provided at the mashup server.

10. The apparatus as recited in claim 1, further comprising a mapping server communicating with the MECA module to provide the map data to the MECA module via the mapping engine.

11. The apparatus as recited in claim 10, wherein the MECA module is provided at the mapping server.

12. The apparatus as recited in claim 1, wherein the at least clustered map content data includes filtered map content data.

13. The apparatus as recited in claim 1, wherein the at least clustered map content data includes unfiltered map content data.

14. A method of map engine clustering automation, the method comprising the steps of:
receiving map data from the map engine;
retrieving a list of postings for processing in relation to the map data;
filtering the list of postings based on criteria so that postings that match the criteria are filtered according to a filtering operation resulting in filtered map points corresponding to postings which were filtered and a first list of remaining postings which were not filtered;
clustering the first list of remaining postings so that postings that are substantially proximate are clustered according to a clustering operation resulting in clustered map points corresponding to postings which were clustered and a second list of remaining postings which were not clustered; and
providing a list of points and related posting information destined to be displayed on a map.

15. The method as recited in claim 14, wherein the clustering step includes the act of comparing two points on the map which are related to two postings.

16. The method as recited in claim 15, wherein the clustering step includes the act of computing a distance between the two points.

17. The method as recited in claim 16, wherein the clustering step includes the act of comparing the distance to a threshold value.

18. The method as recited in claim 16, wherein the distance is measured along a line.

19. The method as recited in claim 18, wherein the line extends from one of the two points to the other of the two points.

20. The method as recited in claim 18, wherein the line is a latitude projection of a line that extends from one of the two points to the other of the two points.

21. The method as recited in claim 18, wherein the line is a longitude projection of a line that extends from one of the two points to the other of the two points.

22. The method as recited in claim 17, wherein the threshold value depends on a current zoom level for a map.

23. The method as recited in claim 14, wherein the clustering operation includes the act of providing a cluster point which is related to at least two postings.

24. The method as recited in claim 23, wherein the cluster point is determined as a function of the location of the at least two postings.

25. The method as recited in claim 24, wherein the cluster point is determined as an average of the locations of the at least two postings.

26. The method as recited in claim 24, wherein the cluster point is determined by selecting a location from the locations of the at least two postings.

27. The method as recited in claim 14, wherein the list of points in the returning step includes the clustered map points and wherein the related posting information includes information related to the postings that were clustered.

28. The method as recited in claim 14, wherein the list of points in the returning step includes the filtered map points and wherein the related posting information includes information related to the postings that were filtered.

29. The method as recited in claim 14, wherein the list of points in the returning step includes map points corresponding to postings which were neither clustered nor filtered and wherein the related posting information includes information related to the postings that were neither clustered nor filtered.

30. The method as recited in claim 14, wherein the list of points in the returning step includes map points corresponding to postings which were either clustered, filtered or neither clustered nor filtered and wherein the related posting information includes information related to the postings that were either clustered, filtered or neither clustered nor filtered.

31. The method as recited in claim 14, wherein the criteria at least includes the criterion that the location of the postings is outside a bounding region, and wherein the filtering operation is to truncate the postings from the list of postings.

32. The method as recited in claim 31, wherein the bounding region is a visible area of a map.

33. The method as recited in claim 31, wherein the bounding region is defined by where a visitor moves to on a visible area of a map.

34. The method as recited in claim 14, wherein the filtering operation further comprising the acts of:
selecting a candidate posting from the list of postings;
identifying matching postings using the criteria and the candidate posting;
creating a point to represent the matching postings identified; and
not listing the identified postings and the candidate posting in the list of remaining postings.

35. The method as recited in claim 34, wherein the filtering operation further comprises the act of determining whether any other candidate posting has not yet been considered for filtering, and if so determined repeating the selecting step with each of the other candidate posting until all candidate postings have been considered for filtering.

36. The method as recited in claim 35, further comprising the step of performing other filtering using another criteria and another filtering operation.

37. The method as recited in claim 14, wherein postings include a mall identifier, and wherein the criteria comprises a criterion of postings that have the same mall identifier.

38. The method as recited in claim 14, wherein postings include a region identifier, and wherein the criteria comprises a criterion of postings that have the same region identifier.

39. The method as recited in claim 14, wherein postings include a company identifier, and wherein the criteria comprises a criterion of postings that have the same company identifier.

40. The method as recited in claim 14, wherein postings include location, and wherein the criteria comprises a criterion of postings that have substantially the same location.

41. The method as recited in claim 40, wherein postings further include a company identifier, and wherein the criteria further comprises a criterion of postings that have the same company identifier.

42. The method as recited in claim 14, wherein postings include location, and wherein the criteria comprises the criterion of postings that are within a radius of the location of the candidate posting at a current zoom level.

43. The method as recited in claim 14, wherein the postings are selected from the group consisting of a job posting and a real-estate posting.

44. The method as recited in claim 14, wherein the map engine is an online mapping service.
